(19) United States
(12) Patent Application Publication
(10) Pub. No.: US 2009/0218898 A1
(43) Pub. Date: Sep. 3, 2009

(54) MULTI FUNCTION ENGINES

(76) Inventor: Renato Bastos Ribeiro, Porto Alegre (BR)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/251,647

(22) Filed: Oct. 15, 2008

Related U.S. Application Data
(60) Provisional application No. 60/980,125, filed on Oct. 15, 2007.

(51) Int. Cl. H02K 16/00

(52) U.S. Cl. 310/112

(57) ABSTRACT

This disclosure describes an arrangement of axially-aligned motors and tubular or solid drive shafts enabling multiple motors and drive shafts to operate within a compact volume. The motors are axially-aligned to each other and each motor comprises a drive shaft that is axially-aligned to the motor and to the other drive shafts. At least one drive shaft is tubular thus allowing one or more drive shafts to fit within each other just as a telescoping apparatus operates. Drive shafts can thus encompass virtually the same space while rotating at the same or different speeds and directions and can have the same or different torques imparted upon them.

### CROSS REFERENCE TO RELATED APPLICATIONS

This application claims the benefit of priority of U.S. Provisional Patent Application Ser. No. 60/980,125, filed Oct. 15, 2007, entitled MULTI FUNCTION ENGINES, the content of which is hereby incorporated by reference in its entirety.

### BACKGROUND

This disclosure relates to motors of various types. Generally motors comprise mechanical systems that convert chemical, kinetic, or electrical energy into linear or rotary motion.

### SUMMARY

This disclosure describes an arrangement of axially-aligned motors and tubular or solid drive shafts enabling multiple motors and drive shafts to operate within a compact volume. The motors are axially-aligned to each other and each motor comprises a drive shaft that is axially-aligned to the motor and to the other drive shafts. At least one drive shaft is tubular thus allowing one or more drive shafts to fit within each other concentrically just as a telescoping apparatus operates. Drive shafts can thus encompass virtually the same space while rotating at the same or different speeds and directions and can have the same or different torques imparted upon them.

One aspect of the disclosure is an apparatus that includes a plurality of axially-aligned motors, and a plurality of drive shafts. The drive shafts are concentric and axially-aligned to each other and axially-aligned to the motors. Each drive shaft has a different radius than all other drive shafts. Each drive shaft is spaced so as to provide a gap between adjacent drive shafts. Each drive shaft is rotatably driven by one of the motors and each drive shaft may simply constitute an extension of its motor rotor. Finally, at least one drive shaft is tubular.

Another aspect of this disclosure describes an apparatus including a first motor having a first axially-aligned tubular drive shaft. The first drive shaft has a first inner and outer radii. A second motor has a second axially-aligned tubular drive shaft. The second drive shaft has a second inner and outer radii. The second inner and outer radii are smaller than the first inner and outer radii. The second motor is axially-aligned with the first motor, and the second drive shaft is concentrically axially-aligned with the first drive shaft. At least a portion of the second drive shaft is arranged within the first drive shaft and provides an annular gap between the first and second drive shafts. A third motor has a third concentric, axially-aligned drive shaft. The third drive shaft has a third inner and outer radii. The third inner and outer radii are smaller than the second inner and outer radii. The third motor is axially-aligned with the second motor, and the third drive shaft is axially-aligned with the second drive shaft. At least a portion of the third drive shaft is arranged within the first and second drive shafts and provides an annular gap between the second and third drive shafts.

### BRIEF DESCRIPTION OF THE DRAWINGS

FIG. 1 is a side perspective view of a first embodiment of an electric motor in accordance with the present disclosure.

FIG. 2 is an end perspective view of the first embodiment shown in FIG. 1.

FIG. 3 is a side perspective view of an embodiment of a system of electric motors in accordance with the present disclosure.

FIG. 4 is a partial end perspective view of the embodiment shown in FIG. 3.

FIG. 5 is a side perspective view of a second embodiment of a system of electric motors in accordance with the present disclosure.

FIG. 6 is a partial end perspective view of the system of motors shown in FIG. 5.

FIG. 7 is a side perspective view of a third system of motors in accordance with the present disclosure.

FIG. 8 is a partial end perspective view of the third system of motors in accordance with the present disclosure.

FIG. 9 is an end perspective view of the third system of motors shown in FIGS. 7 and 8.

### DETAILED DESCRIPTION

The apparatus of the present disclosure includes one or more motors preferably axially aligned to each other, and each having tubular or solid drive shafts further axially aligned to each other and to the one or more motors. Each drive shaft can have a different radius than the other drive shafts. As a result, multiple drive shafts can be concentrically aligned and partially overlapping—similar to the way that the tubes in a telescoping mechanism are arranged. On advantage of this arrangement is that multiple drive shafts can be located in close proximity (taking up little space) and have various rotational directions and velocities, as well as have different torques applied to each drive shaft. Another aspect of the present disclosure is that the multiple drive shafts provide a small annular gap between any two drive shafts having different radii. As such, fluids can pass through these gaps. For instance, cooling fluids could be provided within these gaps, and by causing the fluids to travel through an annular gap in either direction, the fluid can absorb heat from the motors when in proximity to the motors, and transfer the heat away from the motors. Such a cooling system simplifies traditional systems and avoid extraneous piping and other means of transporting cooling fluids. Such a system could also be utilized to preheat fluids before their use in another system.

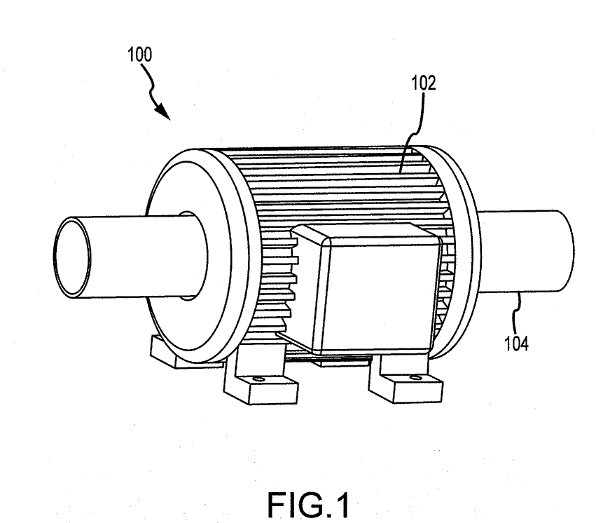

FIG. 1 is a side perspective view of a first embodiment of an electric motor 102 in accordance with the present disclosure. The illustrated embodiment includes a single motor 102 and a single tubular drive shaft 104 axially aligned to the motor 102. The drive shaft 104 can be rotatably driven by the motor 102. Various types of motors are envisioned, for instance: internal combustion engines; alternating current electric motors; direct current electric motors; gas-, air- or water-driven turbine engines; reciprocating engines; steam engines; and piezoelectrically-driven engines, to name a few. Although not visible in the perspective view of FIG. 1, the drive shaft 104 preferably passes completely through the motor 102. In the illustrated embodiment, the drive shaft 104 is tubular and can have any variety of inner and outer diameters. The drive shaft 104 can be made of any rigid or semi-rigid material, such as a metal, ceramic, or even polymers (e.g., acrylonitrile butadiene styrene (ABS), polyvinyl chloride (PVC), vulcanized rubber), amorphous materials (e.g., glass), and organic compounds (e.g., wood), to name a few. The motor 102 is capable of exerting rotational force on the drive shaft 104 in either a clockwise or counterclockwise direction, although in an embodiment a motor 102 can only exert rotational forces in a single direction. The motor 102 is also capable of driving the drive shaft 104 at various rotational velocities. The motor 102 is also capable of exerting various torques on the drive shaft 104.

One embodiment of the motor 102 is a rotary electric motor or alternator. In such an embodiment, the drive shaft 104 can be fixed to a rotor. A stator can be fixed to the inside of the motor 102 and encircle, but not touch, the rotor. The rotor is thus free to spin relative to the stator. Both the rotor and stator can comprise windings of conductive wire or other material. A current passing through the stator windings creates an electric field which induces torque on the rotor and causes the rotor and drive shaft 104 to rotate. In an embodiment, to ensure continuous rotation, the current can be alternated.

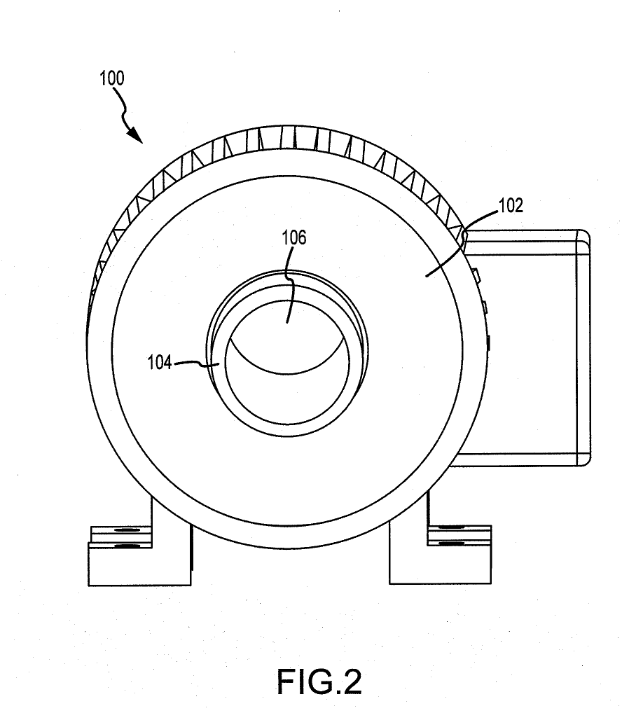

FIG. 2 is an end perspective view of the first embodiment shown in FIG. 1. In the illustrated embodiment, it can be seen that the drive shaft 104 passes through the interior of the motor 102. The drive shaft 104 can be tubular and thus include a hollow or inner region 106.

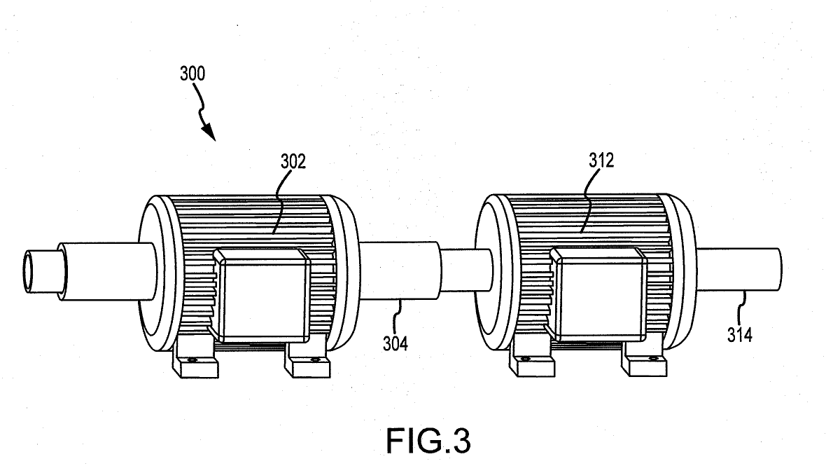

FIG. 3 is a side perspective view of an embodiment of a system 300 of electric motors 302, 312 in accordance with the present disclosure. In the illustrated embodiment, two motors 302, 312 are axially aligned with each other. The motor 302 on the left has a tubular drive shaft 304 axially aligned with the left motor 302 and axially aligned with the right motor 312. The drive shaft 304 on the left also has a first radius. The motor 312 on the right also has a drive shaft 314 axially aligned with both motors 302, 312. This drive shaft 314 has a second radius smaller than the radius of the first drive shaft 304. As the two drive shafts 304, 314 are axially/concentrically aligned and have different radii, the first drive shaft 304 fits around the thinner second drive shaft 314 without contacting the second drive shaft 314. As such, the two drive shafts 304, 314 can rotate in different directions, at different speeds, and can have different torques imparted upon them.

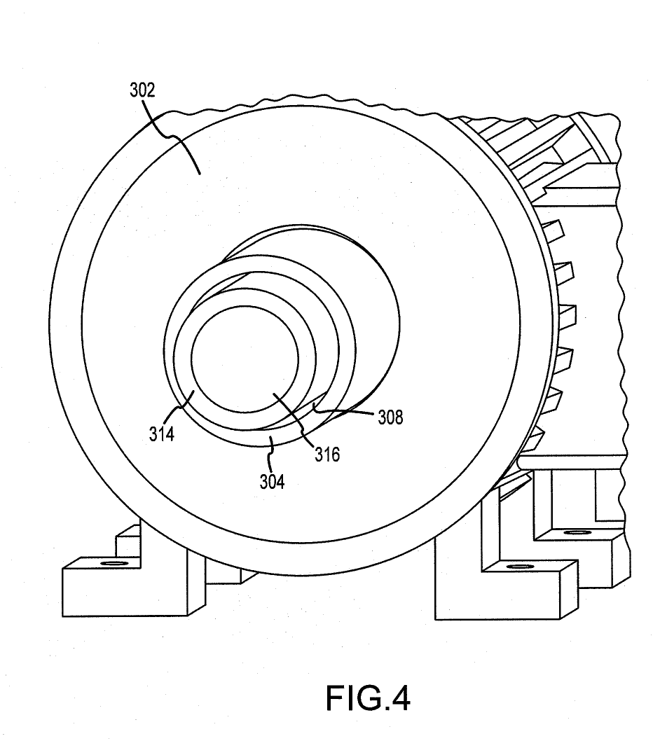

Although the illustrated embodiment shows that the second drive shaft 314 is tubular, in an embodiment, this inner or second drive shaft 314 can be solid. A solid drive shaft may be easier and cheaper to manufacture, may be more resilient and thus able to operate at higher loads, and may have a longer life than a tubular drive shaft. Furthermore, for cooling purposes, the drive shaft 314 itself may transfer heat away from the motor 312. As such, a solid drive shaft may be better able to transfer heat than a tubular drive shaft. In an embodiment, fluid can transport heat away from the motors 302, 312 via an annular gap (see FIG. 4) between the two drive shafts 304, 314. At the same time, if the inner or second drive shaft 314 is tubular, fluid may occupy this hollow region and transport heat away from the motors 302, 312.

FIG. 4 is a partial end perspective view of the embodiment shown in FIG. 3. In FIG. 4, an annular gap 308 between the inner and outer drive shafts 304, 314 can be seen, as well as the hollow region 316 within the inner drive shaft 314. Although not illustrated, it should be understood that both drive shafts 304, 314 pass through the first most motor 302 while only the second drive shaft 314 passes through the second motor 312. However, in an alternative embodiment, both drive shafts 304, 314 may be arranged within, and pass through, both motors 302, 312. In such an embodiment, each motor 302, 312 can drive a single drive shaft. For instance, in the illustrated embodiment, the first motor 302 drives only the first or outer drive shaft 304 while the second motor 312 drives only the inner or second drive shaft 314.

In an embodiment, the motors 302, 312 are electric and each comprise a stator and a rotor. The rotor of the first motor 302 can be fixed to the outer drive shaft 304 while the inner drive shaft 314 passes freely through the first motor 302 and through the outer drive shaft 304 without contacting the outer drive shaft 304. In the illustrated embodiment, the outer drive shaft 304 does not pass through the second motor 312 and as such, the rotor of the second motor 312 can be fixed directly to, or integral with, the inner drive shaft 314.

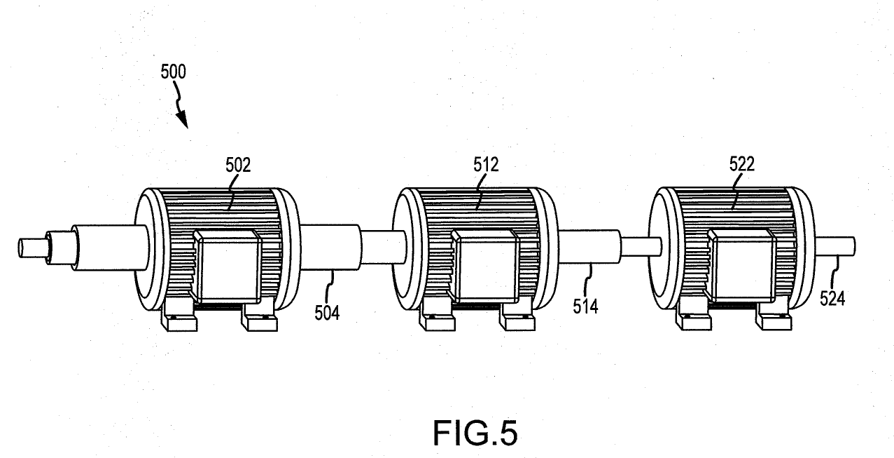

FIG. 5 is a side perspective view of a second embodiment of a system 500 of electric motors 502, 512, 522 in accordance with the present disclosure. The illustrated embodiment includes a first motor 502 having a first axially aligned tubular drive shaft 504, the first drive shaft 504 having a first radius.

The illustrated embodiment also includes a second motor 512 having a second axially aligned tubular drive shaft 514. The second drive shaft 514 has a second radius being smaller than the first radius. The second motor 512 is axially aligned with the first motor 504, and the second drive shaft 514 is axially aligned with the first drive shaft 504. As seen, at least a portion of the second drive shaft 514 is arranged within the first drive shaft 504. An annular gap can be provided between the first and second drive shafts 502, 512.

The system 500 also includes a third motor 522 having a third axially aligned drive shaft 524. The third drive shaft 524 has a third radius, wherein the third radius is smaller than the second radius and the first radius. The third motor 522 is axially aligned with the second motor 512 and the third drive shaft 524 is axially aligned with the second drive shaft 514. At least a portion of the third drive shaft 524 is arranged within the first and second drive shafts 514, 504. An annular gap is provided between the second and third drive shafts 514, 524 in regions where the second and third drive shafts 514, 524 overlap. In the illustrated embodiment, the three different drive shafts 504, 514, 524 can be driven in different directions, at different speeds, and can have different torques applied to each drive shaft 504, 514, 524.

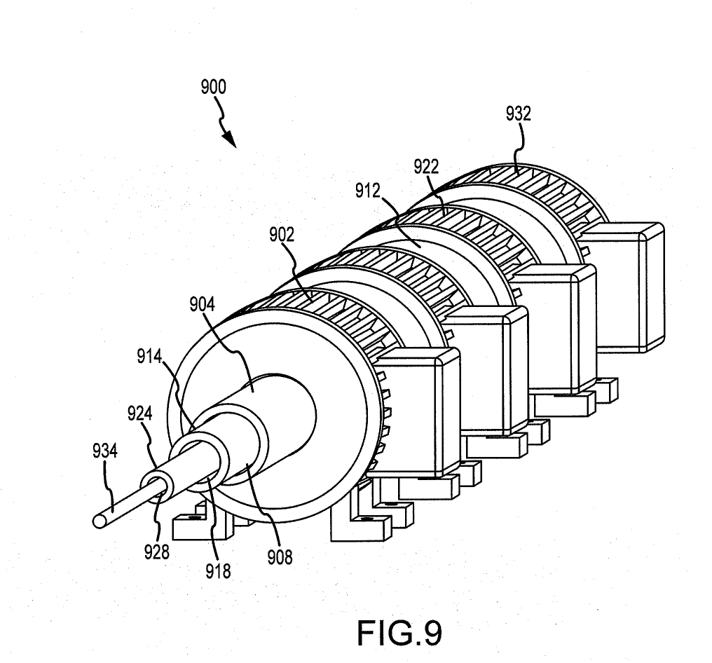

Although the motors 502, 512, 522 are illustrated as being spaced from each other laterally, other embodiments could include less/greater spacing between motors 502, 512, 522, or no spacing. An embodiment in which the motors 502, 512, 524 are not spaced from each other can be seen in FIG. 9.

In an embodiment, the motors 502, 512, 522 drive the drive shafts 504, 514, 524 in the same direction, at the same speed, and/or apply equivalent torque to all three drive shafts 504, 514, 524. In other embodiments, any combination of speed, direction, and/or torque can be applied to any combination of one or more of the drive shafts 504, 514, 524. In an embodiment, the inner drive shaft 524 can be tubular or solid. Although in the illustrated embodiment a portion of each drive shaft 504, 514, 524 is provided to the right of each motor 502, 512, 522, in another embodiment the three drive shafts 504, 514, 524 may only be provided within each motor 502, 512, 522, and to the left of each motor 502, 512, 522.

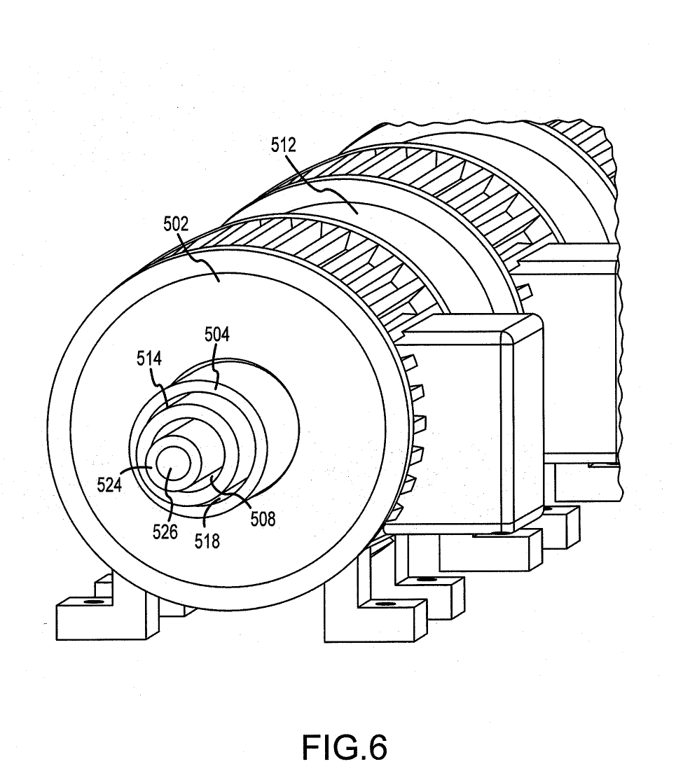

FIG. 6 is a partial end perspective view of the system of motors 500 shown in FIG. 5. In the illustrated embodiment, the inner drive shaft 524 is tubular. However, in an embodiment, the inner drive shaft 524 can be solid. An annular gap 508 can be seen between the inner and middle drive shafts 524, 514 as well as the gap 508 between the middle and outer drive shafts 514, 504. As noted in earlier FIGS., these gaps 508, 518 can be filled with fluid. In an embodiment, this fluid can transport heat or thermal energy to or from the motors 502, 512, 522. In an embodiment having a plurality of gaps 508, 518, such as illustrated in FIG. 6, fluid may flow in different directions. In an embodiment, fluid may flow in one of, but not all of the gaps 508, 518. In an embodiment, different fluids can flow in different gaps 508, 518. In an embodiment, a hollow region 526 within the inner driveshaft 524 can also be a conduit for fluid. Other combinations are also envisioned.

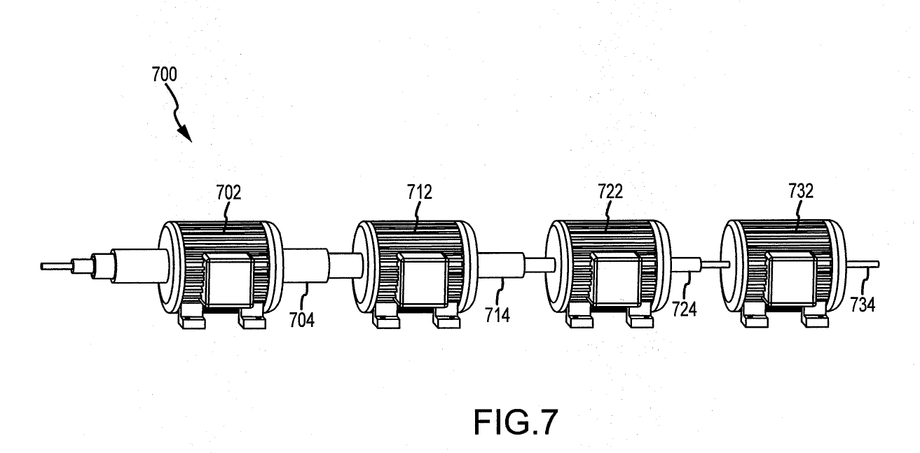

FIG. 7 is a side perspective view of a third system 700 of motors 702, 712, 722, 732 in accordance with the present disclosure. The system 700 includes a first motor 702 having a first axially aligned tubular drive shaft 704. The first drive shaft 704 has a first radius. The system 700 also includes a second motor 712 having a second axially aligned tubular drive shaft 74. The second drive shaft 714 has a second a radius, wherein the second radius is smaller than the first radius. The second motor 712 is axially aligned with the first motor 702 and the second drive shaft 714 is axially aligned with the first drive shaft 704. At least a portion of the second drive shaft 714 is arranged within the first drive shaft 704 and provides an annular gap between the first and second drive shafts 704, 714. The system 700 also includes a third motor 722 having a third axially aligned drive shaft 724. The third drive shaft 724 has a third radius, wherein the third radius is smaller than the second radius. The third motor 722 is axially aligned with the second motor 712 and the third drive shaft 724 is axially aligned with the second drive shaft 714. At least a portion of the third drive shaft 724 is arranged within the first and second drive shafts 704, 714 and provides an annular gap between the second and third drive shafts 714, 724. The system 700 also includes a fourth motor 732 having a fourth axially aligned drive shaft 734. The fourth drive shaft 734 has a fourth radius, wherein the fourth radius is smaller than the third radius. The fourth motor 732 is axially aligned with the third motor 722 and the fourth drive shaft 734 is axially aligned with the third drive shaft 724. At least a portion of the fourth drive shaft 734 is arranged within the first, second, and third drive shafts 704, 714, 724 and provides an annular gap between the third and fourth drive shafts 724, 734.

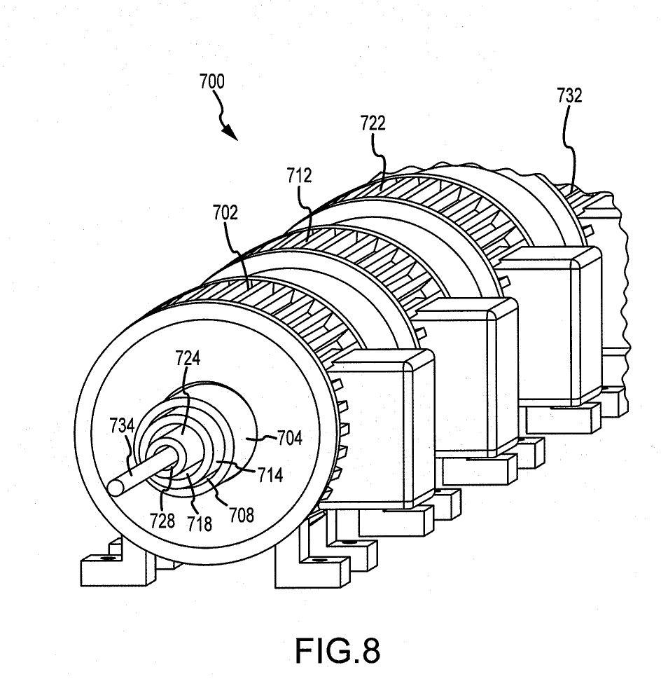

FIG. 8 is a partial end perspective view of the third system 700 of motors 702, 712, 722, 724 in accordance with the present disclosure. In this embodiment, the inner or fourth drive shaft 734 is solid. However, in alternative embodiments, the inner or fourth drive shaft 734 can be tubular and have a hollow region. As can be seen, an annular gap 708, 718, 728 is provided between each pair of drive shafts 704, 714, 724, 734. In such an embodiment, each drive shaft 704, 714, 724, 734 may be driven at a different speed, in a different direction, and have a different torque applied to each drive shaft 704, 714, 724, 734. In an alternative embodiment, each drive shaft 704, 714, 724, 734 may be driven in the same direction, at the same speed, and/or have the same torque applied to it. In alternative embodiments, any combination of different or similar speeds, directions, and/or torques may be applied to the drive shafts 704, 714, 724, 734.

FIG. 9 is an end perspective view of the third system 900 of motors 902, 912, 922, 924 shown in FIGS. 7 and 8. FIG. 9 illustrates an embodiment in which there is no gap between each motor 902, 912, 922, 924. In other words, the motors 902, 912, 922, 924 are in contact with each other or are provided with only a minimal gap between each motor 902, 912, 922, 924. An advantage of such an arrangement is that the system 900 of motors 902, 912, 922, 932 is compact. As such, the illustrated system 900 can provide four different speeds, directions of rotation, and/or torques to the drive shafts 904, 914, 924, 934 which can be used to rotate or drive other systems, and such a system 900 of variable forces can be implemented in a very small and compact space/volume.

While various embodiments of the present disclosure have been described in detail, it is apparent that modifications and adaptations of those embodiments will occur to those skilled in the art. However, it is to be expressly understood that such modifications and adaptations are within the spirit and scope of the present disclosure.

What is claimed is:

1. An apparatus comprising:
a plurality of axially-aligned motors; and
a plurality of drive shafts:
axially-aligned to each other;
axially-aligned to the motors;
each having a different radius than all other drive shafts and spaced so as to provide a gap between adjacent drive shafts;
each drive shaft being rotatably driven by one of the motors; and
wherein at least one drive shaft is tubular.

2. The apparatus of claim 1, wherein the one or more drive shafts rotate in different directions.

3. The apparatus of claim 1, wherein the one or more drive shafts rotate in the same direction.

4. The apparatus of claim 1, wherein the drive shafts rotate at different rotational velocities.

5. The apparatus of claim 1, wherein the innermost drive shaft is solid.

6. The apparatus of claim 1, wherein all the drive shafts are tubular.

7. The apparatus of claim 1 wherein each motor is an electric motor.

8. An apparatus comprising:
a first motor having a first axially-aligned tubular drive shaft, the first drive shaft having a first inner and outer radii;
a second motor having a second axially-aligned tubular drive shaft, the second drive shaft having a second inner and outer radii, the second inner and outer radii being smaller than the first inner and outer radii, the second motor being axially-aligned with the first motor, the second drive shaft being axially-aligned with the first drive shaft, and at least a portion of the second drive shaft being arranged within the first drive shaft and providing an annular gap between the first and second drive shafts; and
a third motor having a third axially-aligned drive shaft, the third drive shaft having a third inner and outer radii, the third inner and outer radii being smaller than the second inner and outer radii, the third motor being axially-aligned with the second motor, the third drive shaft being axially-aligned with the second drive shaft, and at least a portion of the third drive shaft being arranged within the first and second drive shafts and providing an annular gap between the second and third drive shafts.

9. The apparatus of claim 8, wherein the drive shafts rotate in different directions.

10. The apparatus of claim 8, wherein the drive shafts rotate in the same direction.

11. The apparatus of claim 8, wherein the drive shafts rotate at different rotational velocities.

12. The apparatus of claim 8, wherein the third drive shaft is solid.

13. The apparatus of claim 8, wherein the third drive shaft is tubular.

14. The apparatus of claim 8 wherein each of the motors is an electric motor.
